(19) United States
(12) Patent Application Publication
(10) Pub. No.: US 2026/0135328 A1
(43) Pub. Date: May 14, 2026

(54) ELECTRODE TERMINAL, COMPRESSOR AND REFRIGERATION DEVICE

(71) Applicant: GUANGDONG MEIZHI COMPRESSOR CO., LTD., Foshan (CN)

(72) Inventors: Bofu TAN, Foshan (CN); Rong LIANG, Foshan (CN); Xiongfei JIANG, Foshan (CN)

(21) Appl. No.: 19/429,793

(22) Filed: Dec. 22, 2025

Related U.S. Application Data
(63) Continuation of application No. PCT/CN2024/097853, filed on Jun. 6, 2024.

(30) Foreign Application Priority Data
Nov. 27, 2023 (CN) 202311601747.8
Nov. 27, 2023 (CN) 202323217188.9

(51) Int. Cl. H01R 13/52; F25B 31/00; H01R 105/00

(52) U.S. Cl. CPC H01R 13/5213; F25B 31/00; H01R 2105/00

(57) ABSTRACT

Disclosed are an electrode terminal, a compressor and a refrigeration device. The electrode terminal is applied in the compressor and includes: an outer cover including a base plate and a surrounding plate connected to the outer periphery of the base plate; at least three electrodes passing through the base plate and insulated from the base plate; and a protective cover including at least three protective units, the three protective units are respectively sleeved at the three electrodes.

### CROSS-REFERENCE TO RELATED APPLICATIONS

The present application is a continuation application of International (PCT) Patent Application No. PCT/CN2024/097853, filed on Jun. 6, 2024, which claims priority to Chinese Patent Application No. 202311601747.8 and Chinese Patent Application No. 202323217188.9, filed on Nov. 27, 2023, the entire contents of which are incorporated herein by reference.

### TECHNICAL FIELD

The present application relates to the field of refrigeration devices, and in particular to an electrode terminal, a compressor and a refrigeration device.

### BACKGROUND

A compressor is a driven fluid machine that boosts low-pressure gas to high-pressure gas. It draws low-temperature, low-pressure refrigerant gas from an intake pipe, compresses it through a motor-driven piston, and discharges high-temperature, high-pressure refrigerant gas to an exhaust pipe, providing power for the refrigeration cycle.

During the operation of the compressor, copper cuttings brought in by the refrigerant in the pipes are easily attached to the electrode terminals, which can easily cause short circuit and burning of the electrode terminals, and thus cause most electrode terminal failures.

### SUMMARY

The present application provides an electrode terminal designed to reduce the possibility of metal debris flowing with oil and refrigerant adhering to the electrode.

An electrode terminal described in the present application, applied to a compressor, includes:
an outer cover including a base plate and a surrounding plate connected to outer periphery of the base plate;
at least three electrodes passing through the base plate and insulated from the base plate; and
a protective cover including at least three protective units, three protective units are respectively sleeved at the three electrodes.

In some embodiments, two adjacent protective units are connected to each other.

In some embodiments, two adjacent protective units are fixedly connected to each other.

In some embodiments, two adjacent protective units are glued to each other

In some embodiments, at least three protective units are integrally formed.

In some embodiments, at least one connection rib is provided between the two adjacent protective units.

In some embodiments, the two adjacent protective units are detachably connected.

In some embodiments, the two adjacent protective units are slidably connected.

In some embodiments, the two adjacent protective units are buckled with each other.

In some embodiments, a connection member is provided between the two adjacent protective units.

In some embodiments, the two adjacent protective units are magnetically connected.

In some embodiments, the two adjacent protective units are movably connected.

In some embodiments, the two adjacent protective units are rotatably connected.

In some embodiments, the at least three protective units are provided with accommodation grooves for accommodating the at least three electrode respectively, each of the at least three protective units includes a first cylinder and a second cylinder of different lengths, the first cylinder and the second cylinder respectively sleeved at each of the at least three electrodes, the second cylinder exposes a top of each electrode for connection to a protector.

In some embodiments, an exposed length of the top of each electrode is greater than or equal to 5 mm.

In some embodiments, an isolation gap is provided between the protective cover and the surrounding plate.

In some embodiments, the isolation gap has a width greater than or equal to 0.1 mm.

In some embodiments, an avoidance port is provided between two first cylinders adjacent to the second cylinder, and is configured to avoid the protector.

In some embodiments, an abutment portion is formed to protrude from an inner wall of the accommodation groove of the first cylinder, and the abutment portion abuts against a top surface of the electrode.

In some embodiments, the abutment portion abuts against a portion of the top surface of the electrode.

In some embodiments, the electrode is provided with an electrode sheet, and in the first cylinder, the electrode sheet is provided within the accommodation groove; and

in the second cylinder, the electrode sheet passes through the accommodation groove and is electrically connected to the protector.

In some embodiments, a fixation portion is provided within the accommodation groove, and abuts against the electrode.

In some embodiments, the fixation portion is provided with an arc-shaped notch groove, and the electrode abuts against a wall of the arc-shaped notch groove.

In some embodiments, the first cylinder is provided with a reserved slot at a top, and the reserved slot is configured to install a plug-in terminal.

In some embodiments, the first cylinder is provided with a wire groove at a top, and the wire groove is configured to accommodate a wire.

In some embodiments, an insulator is provided between the electrode and the base plate, the electrode passes through the insulator and is electrically connected to outside, and the insulator is made of at least one of glass crystal or ceramic.

In some embodiments, the protective unit is sleeved at the insulator.

In some embodiments, a side wall of the accommodation groove is provided with an adapting groove for accommodating the insulator.

In some embodiments, a plurality of reinforcement ribs are provided between the base plate and the surrounding plate.

The present application further proposes a electrode terminal, applied to the compressor, and the electrode terminal includes:
an outer cover including a base plate and a surrounding plate connected to the outer periphery of the base plate, the base plate and the surrounding plate are integrally formed;
three electrodes passing through the base plate and insulated from the base plate; and
a protective cover including three protective units, three protective units are respectively sleeved at the three electrodes,
the three protective units are provided with two first cylinders and one second cylinder, and the top of one of the three electrodes is exposed through the second cylinder; and the exposed length of the top of the electrode is not less than 5 mm, and an isolation gap is provided between the protective cover and the surrounding plate.

In some embodiments, two adjacent protective units are connected to each other.

In some embodiments, the three protective units are integrally formed.

In some embodiments, the protective unit is provided with an accommodation groove for accommodating the electrode; the exposed top end of the electrode is used for connection to the protector.

The present application further proposes a electrode terminal, applied to the compressor, and the electrode terminal includes:
an outer cover including a base plate and a surrounding plate connected to the outer periphery of the base plate;
three electrodes passing through the base plate and insulated from the base plate; and
a protective cover including three protective units, three protective units are respectively sleeved at the three electrodes,
the protective unit is provided with an accommodation groove for accommodating the electrode; an abutment portion is formed to protrude from the inner wall of the accommodation groove, and the abutment portion abuts against the top surface of the electrode; and a fixation portion is provided in the accommodation groove and abuts against the electrode.

In some embodiments, two adjacent protective units are connected to each other.

In some embodiments, the three protective units are integrally formed.

In some embodiments, the protective unit includes a first cylinder and a second cylinder of different lengths, and the first cylinder and the second cylinder are respectively sleeved at the electrode; the second cylinder exposes the top of the electrode, and the exposed top of the electrode is used to connect to the protector.

The present application further proposes a protective assembly for a compressor, and the compressor is provided with a plurality of electrodes. The protective assembly includes:
a protector configured to connect to the electrodes inside the compressor; and
a protective cover including a plurality of protective units, the number of the protective units is not less than the number of electrodes, and the plurality of protective units are respectively sleeved at the plurality of electrodes.

The present application further describes a compressor including the electrode terminal as described above.

The present application further describes a refrigeration device including the compressor as described above.

### BRIEF DESCRIPTION OF THE DRAWINGS

To more clearly illustrate the technical solutions in the embodiments of the present application or in the related art, accompanying drawings required in the description of the embodiments or the related art will be described briefly below. Obviously, the accompanying drawings described below are only some embodiments of the present application. For those skilled in the art, without inventive efforts, other drawings can also be obtained based on the structures shown in these drawings.

FIG. 1 is a schematic structural diagram of an electrode and an outer cover structure of an electrode terminal according to the present application.

FIG. 2 is a schematic structural diagram when a protective cover of the electrode terminal is sleeved at the electrode according to the present application.

FIG. 3 is a schematic structural diagram when two protective units are connected by connection ribs.

FIG. 4 is a schematic structural diagram when three protective units are connected by connection ribs.

FIG. 5 is a schematic structural diagram when three protective units are connected by connection ribs.

FIG. 6 is a schematic structural diagram when two protective units are slidingly connected.

FIG. 7 is a schematic structural diagram when three protective units are slidingly connected.

FIG. 8 is a schematic structural diagram when three protective units are slidingly connected.

FIG. 9 is a schematic structural diagram when three protective units are slidingly connected.

FIG. 10 is a schematic structural diagram when two protective units are slidingly fastened.

FIG. 11 is a schematic structural diagram when three protective units are slidingly fastened.

FIG. 12 is a schematic structural diagram when two protective units are fastened.

FIG. 13 is a schematic structural diagram when three protective units are fastened.

FIG. 14 is a schematic structural diagram when two protective units magnetically attracted.

FIG. 15 is a schematic structural diagram when three protective units magnetically attracted.

FIG. 16 is a schematic structural diagram when two protective units are connected by a connection member.

FIG. 17 is a schematic structural diagram when three protective units are connected by the connection member.

FIG. 18 is a schematic structural diagram when two protective units are connected by rotation.

FIG. 19 is a schematic structural diagram when two protective units are connected by rotation.

FIG. 20 is a schematic structural diagram of the protective cover of the electrode terminal according to the present application.

FIG. 21 is a schematic structural diagram of the protective cover of the electrode terminal from another perspective.

FIG. 22 is a schematic structural diagram of the protective cover of the electrode terminal from yet another perspective.

FIG. 23 is a schematic structural diagram when the electrode terminal is directly connected to the protector.

FIG. 24 is a schematic structural diagram when the electrode terminal is connected to the protector after sleeved on the protective cover according to the present application.

FIG. 25 is an exploded schematic structural diagram of FIG. 24.

FIG. 26 is a schematic diagram of a protective assembly according to the present application.

### DESCRIPTION OF REFERENCE SIGNS

| reference sign | name |
|---|---|
| 100 | outer cover |
| 110 | base plate |
| 120 | surrounding plate |
| 130 | reinforcement rib |
| 140 | embedding ring |
| 200 | electrode |
| 210 | electrode sheet |
| 220 | insulator |
| 230 | top of electrode |
| 300 | protective cover |
| 310 | protective unit |
| 311 | accommodation groove |
| 312 | fixation portion |
| 313 | arc-shaped notch groove |
| 320 | first cylinder |
| 321 | avoidance port |
| 322 | abutment portion |
| 323 | reserved slot |
| 324 | wire groove |
| 325 | top of first cylinder |
| 326 | bottom of first cylinder |
| 330 | second cylinder |
| 331 | top of second cylinder |
| 340 | adapting groove |
| 410 | connection rib |
| 421 | sliding protrusion |
| 422 | sliding groove |
| 423 | positioning protrusion |
| 424 | positioning groove |
| 431 | fastening groove |
| 432 | fastening portion |
| 433 | fastening body |
| 434 | fastening groove |
| 435 | fastening protrusion |
| 440 | connection member |
| 450 | magnet |
| 461 | rotation groove |
| 462 | rotation shaft |
| 500 | wire |
| 510 | plug-in terminal |
| 600 | protector |
| 700 | accommodating portion |

The realization of the objectives, functional features and advantages of the present application will be further explained in conjunction with embodiments and with reference to the accompanying drawings.

### DETAILED DESCRIPTION OF THE EMBODIMENTS

The technical solutions in the embodiments of the present application will be described clearly and completely below in conjunction with the accompanying drawings. Obviously, the described embodiments are only some rather than all of the embodiments of the present application. Based on the embodiments of the present application, all other embodiments obtained by those skilled in the art without inventive efforts are within the scope of the present application.

It should be noted that if the embodiments of the present application involve directional indications (such as up, down, left, right, front, back, etc.), such directional indications are only used to explain the relative position relationship, movement status, etc. between the various components under a certain specific posture (as shown in the figures). If the specific posture changes, the directional indication will also change accordingly.

In addition, if there are descriptions such as “first”, “second”, etc. in the embodiments of the present application, the descriptions of “first”, “second”, etc. are only for descriptive purposes and cannot be understood as indicating or implying their relative importance or implicitly indicating the number of the indicated technical features. Therefore, the features defined as “first” or “second” may explicitly or implicitly include at least one of such features. In addition, “and/or” in the full text means including three parallel solutions, taking “A and/or B” as an example, it includes solution A, solution B, or solutions that meet both A and B. In addition, the technical solutions between the various embodiments can be combined with each other, but they must be based on the fact that those skilled in the art can implement them. When the combination of technical solutions is mutually contradictory or cannot be implemented, it should be deemed that such a combination of technical solutions does not exist and is not within the scope of the present application.

The present application describes an electrode terminal, applied to a compressor. The electrode terminal provided in the present application can provide electrical connections between the interior and exterior of the compressor.

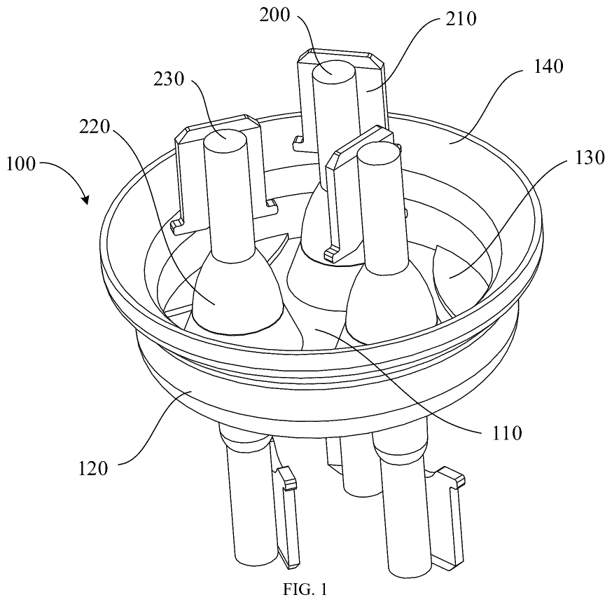

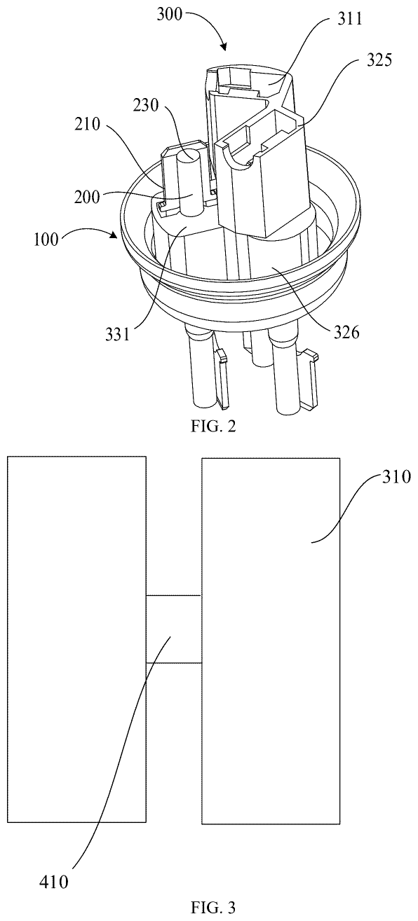

Referring to FIGS. 1 and 2, the compressor includes an outer casing, and the outer casing is provided with an embedded groove for embedding the electrode terminal. Since the compressor contains a liquid medium such as refrigerant or oil, the electrode terminal is typically sealed and fixed in the embedded groove. Accordingly, to prevent the refrigerant or oil from leaking out of the electrode terminal, the electrode terminal is typically installed in the embedded groove by welding.

In the present application, the electrode terminal includes an outer cover 100 and a plurality of electrodes 200. The plurality of electrodes 200 are provided in the outer cover 100, and the outer cover 100 is embedded in the embedded groove on the outer casing of the compressor. Generally, the outer cover 100 is circular and made of metal, facilitating welding and securing the outer cover 100 to the embedded groove through melting. Specifically, the outer cover 100 includes a base plate 110 and a surrounding plate 120 connected to an outer periphery of the base plate 110. Both the base plate 110 and the surrounding plate 120 are made of metal, so that the outer cover 100 as a whole can be fixed or processed by melting.

In some embodiments, the surrounding plate 120 is integrally formed at the base plate 110, that is, the outer cover 100 can be manufactured as a whole by an integral molding process such as stamping. The junction between the surrounding plate 120 and the base plate 110 is chamfered to ensure that the thickness of the surrounding plate 120 and the base plate 110 remains consistent, thereby ensuring the overall structural strength of the outer cover 100. It should be noted that, in some embodiments, the base plate 110 is provided on one side of the surrounding plate 120. With the base plate 110 as a reference, in the surrounding plate 120, the enclosed area of the surrounding plate 120 cut by a plane parallel to the base plate 110 gradually increases in a direction away from the base plate 110. That is, a projection of the surrounding plate 120 on the plane perpendicular to the base plate 110 is similar to a frustum. Furthermore, when viewed from the direction facing the base plate 110, the maximum projected area of the surrounding plate 120 is greater than the projected area of the embedded groove. Thus, provision of the surrounding plate 120 allows a portion of the surrounding plate 120 to be stuck outside the embedded groove when the outer cover 100 is embedded in the embedded groove. This allows the outer cover 100 to be less likely to fall out of the embedded groove due to the influence of gravity on the electrode terminal during assembly of the electrode terminal, thereby facilitating welding operations on the electrode terminal. Furthermore, an embedded ring 140 can be formed on the side of the surrounding plate 120 away from the base plate 110 by a process such as stamping. The diameter of the embedded ring 140 is greater than the diameter of the embedding groove. This allows the outer cover 100 to be installed in the embedding groove in a certain direction by gravity and is not easy to fall out, thereby facilitating welding of the outer cover 100. In addition, to ensure the structural strength between the surrounding plate 120 and the embedded ring 140, chamfers can also be used between the surrounding plate 120 and the embedded ring 140 to ensure a smooth transition between the two, so that the surrounding plate 120 and the embedded ring 140 have the same thickness.

To further improve the strength between the surrounding plate 120 and the base plate 110, a plurality of reinforcement ribs 130 are provided between the base plate 110 and the surrounding plate 120. The plurality of reinforcement ribs 130 are connected between the base plate 110 and the surrounding plate 120, thereby improving the structural strength between the base plate 110 and the surrounding plate 120. Specifically, the plurality of reinforcement ribs 130 can be in the shape of a strip, i.e., both ends of each reinforcement rib 130 are connected to the base plate 110 and the surrounding plate 120 respectively, thereby reducing the possibility of deformation of the base plate 110 and the surrounding plate 120. Accordingly, in some embodiments, the reinforcement rib 130 may be plate-shaped; for example, the reinforcement rib 130 may be an arc-shaped plate, that is, the arc-shaped side of the reinforcement rib 130 is connected to the surrounding plate 120, and one side of the reinforcement rib 130 is connected to the base plate 110. Alternatively, the reinforcement rib 130 can be triangular plate-shaped, that is, the both sides of the reinforcement rib 130 are connected to the base plate 110 and the surrounding plate 120 respectively. The provision of the reinforcement rib 130 can further enhance the connection strength between the surrounding plate 120 and the base plate 110, thereby reducing the possibility of excessive deformation of the outer cover 100 as a whole due to the cooperation between the surrounding plate 120 and the embedded groove during installation, further ensuring the stability of the overall structure and reducing the difficulty of installing the outer cover 100.

It should be noted that the above description only uses the circular shape of the outer cover 100 to explain the production and installation of the outer cover 100. The outer cover 100, that is, the specific shape of the projection of the base plate 110 on its parallel plane, can be changed according to actual selection and design needs. For example, geometric shapes such as rectangle, square, triangle, rhombus and trapezoid can be used. Irregular shapes can also be used. In addition, integrated molding methods such as stamping can also be used to complete the processing of complex shapes. The shapes of the surrounding plate 120, the embedding groove and the embedded ring 140 can all be changed as the shape of the base plate 110 changes. In addition, according to actual processing or design requirements, the specific materials of the base plate 110, the surrounding plate 120, the embedded ring 140 and the embedding groove can also be selected. For example, the entire outer cover 100 can be made of an insulating material such as hard plastic to improve the overall insulation performance of the outer cover 100.

The electrode 200 is provided at the base plate 110. Specifically, the electrode 200 passes through the base plate 110 and is insulated from the base plate 110, that is, the base plate 110 provides support and fixation for the electrode 200 while being insulated from the electrode 200. It should be noted that the number of electrodes 200 can be set according to actual usage requirements; further, according to the number of electrodes 200 designed on the base plate 110, a plurality of electrode terminals can be provided at the outer casing of the compressor.

In some embodiments, one, two or more electrodes 200 can be provided. When a plurality of electrodes 200 are provided, the plurality of electrodes 200 can be arranged on the same straight line, or two adjacent electrodes 200 can be on the same straight line. When the outer cover 100 is made of metal, to reduce the possibility of electrical conduction between the electrode 200 and the outer cover 100, an insulator 220 is provided between the electrode 200 and the base plate 110. The electrode 200 passes through the insulator 220 to be electrically connected to the outside, that is, the electrode 200 provides electrical conductivity inside and outside the compressor. The provision of the insulator 220 reduces the possibility of electrical conduction between the electrode 200 and the outer cover 100, that is, reduces the possibility of metal debris adhered to the electrode 200 along with the refrigerant or oil being conducted to the outer cover 100.

Accordingly, the insulator 220 is made of an insulating material. To cope with the high temperature that may be generated when the electrode 200 is conducting electricity, the insulator 220 is preferably made of glass crystal or ceramic material. For example, the insulator 220 can be made of glass crystal, can be made of a combination of glass crystal and ceramic, or can be made of ceramic material. The glass crystal and the ceramic have excellent insulation and heat resistance properties and are inexpensive. Therefore, the insulator 220 made of glass crystal or ceramic has excellent insulation and heat resistance properties while being relatively inexpensive. It should be noted that the insulator 220 can also be made of materials such as heat-resistant plastic to ensure good insulation performance and good heat resistance.

In some embodiments, to reduce the possibility of metal debris coming with the refrigerant or oil being placed on the electrode 200, thereby causing a short circuit between the electrodes 200, some embodiments provide an electrode terminal, and a protective cover 300 is provided at the electrode 200. The provision of the protective cover 300 reduces the possibility of metal debris being placed on the electrode 200, thereby reducing the possibility of a short circuit between the electrodes 200, and ensuring the service life of the electrode terminal.

Specifically, the protective cover 300 includes a plurality of protective units 310, the number of which corresponds to the number of electrodes 200. Each protective unit 310 is made of an insulating material.

When only one electrode 200 is provided, the protective cover 300 is a single protective unit 310. It should be noted that the protective unit 310 is sleeved at the electrode 200, thereby reducing the possibility of metal debris adhering to the electrode 200. In other words, the provision of the protective cover 300 further reduces the possibility of a short circuit between the electrode 200 and the outer cover 100, thereby ensuring the service life of the electrode terminal.

When only one electrode 200 is provided at the electrode terminal, the number of electrode terminals and their distribution on the compressor housing can be selected based on the specific design requirements of the compressor, and the compressor is not limited to having only one electrode terminal. For example, in a typical circuit configuration, the compressor is provided with a ground wire, a live wire and a neutral wire. Therefore, three electrode terminals can be provided at the outer casing of the compressor, and the electrodes 200 of the three electrode terminals are all covered with the protective cover 300 (a single protective unit 310), and the three electrode terminals are connected to the ground wire, the live wire and the neutral wire, respectively.

When two electrodes 200 are provided at the base plate 110, two protective units 310 are also provided. The two protective units 310 together form the protection cover 300. The two protective units 310 can exist independently or as a whole. It should be noted that when two electrodes 200 are provided at the base plate 110, it is possible to choose whether to increase the number of electrode terminals according to actual use needs. The electrode terminal here can be an electrode terminal with two electrodes 200, or can be an electrode terminal with one electrode 200 mentioned in the above description, which can be changed and set accordingly according to the specific design requirements of the compressor.

When the protective unit 310 exists independently, the two protective units 310 are respectively sleeved at the two electrodes 200. When refrigerant or oil passes through the area where the electrodes 200 are provided, the refrigerant or oil may carry debris generated by other metal parts of the compressor, such as copper chips in the refrigerant pipeline. When the metal debris adheres to the protective unit 310, the protective unit 310 will use its insulating properties to prevent the metal debris from directly adhering to the electrode 200, thereby reducing the possibility of a short circuit between the two electrodes 200 due to the conduction of the metal debris.

In other embodiments of the present application, two protective units 310 may be connected to each other. It should be noted that whether or not two adjacent protective units 310 are connected and the connection relationship, does not affect the isolation effect of the protective unit 310 on metal debris. In addition, the connection of two adjacent protective units 310 will improve the integrity of the protective cover 300, thereby improving the integrity of the entire electrode terminal, and thus simplifying the production process of the electrode terminal to a certain extent.

There are various ways to connect two adjacent protective units 310, for example, two adjacent protective units 310 are fixedly connected.

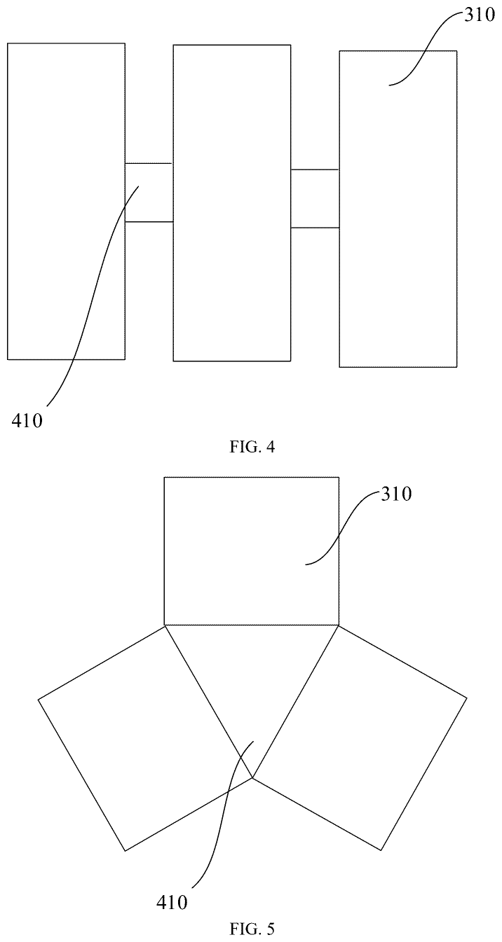

Referring to FIGS. 3 to 5, in some embodiments of the present application, a connection rib 410 is provided between two adjacent protective units 310. The number of the connection ribs 410 may be one or more, and may be specifically selected according to the required connection strength between the protective units 310. The shape of the connection rib 410 may be a bar, that is, both ends of the connection rib 410 are connected to the two protective units 310 respectively. The connection rib 410 may also be made into a plate shape, that is, the opposite sides of the connection rib 410 are respectively connected to the two protective units 310. In addition, with the front view direction of the connection rib 410 as a reference, the connection rib 410 may also be in the shape of a regular polygon such as a hexagon, and the two protective units 310 are respectively connected to the opposite sides or both sides of the connection rib 410.

It should be noted that the specific shape and quantity of the connection ribs 410 can be selected according to needs; for example, the projection of the connection rib 410 in the front view direction is a regular shape such as a rectangle and a square, or an irregular shape. The number of connection ribs 410 can be one, two, three or four, etc., which can be selected according to actual needs; and during installation, the two protective units 310 can be installed as a whole, that is, the two protective units 310 are respectively sleeved at the two electrodes 200 at the same time.

In some embodiments of the present application, the two protective units 310 are glued to each other when they are respectively sleeved at the two electrodes 200. The two protective units 310 may be pre-glued when they are sleeved at the electrodes 200, or may be glued after they are sleeved at the electrodes 200. It should be noted that there is no restriction on the type of glue used for gluing, as long as it maintains good stability in the refrigerant or oil. In addition, hot melt adhesive may also be used to glue the two protective units 310, that is, the two protective units 310 may be glued together in advance using hot melt adhesive.

When the protective units 310 are made of a thermoplastic material such as rubber or plastic, the properties of the material itself can also be utilized for bonding; that is, heating is used to weld the contact surfaces of the two protective units 310, thereby completing the bonding between the two protective units 310. This bonding method utilizing the inherent properties of the material of the protective units 310 can be completed before or after the protective units 310 are sleeved at the electrode 200, depending on the actual production process.

In some embodiments of the present application, the two protective units 310 are integrally formed, so that the two protective units 310 directly form the protective cover 300, without the need for other structures to establish a connection between the two protective units 310. The dimensions of the protective units 310 and the overall dimensions of the protective cover 300 formed by the two protective units 310 can be designed in advance based on the spacing between the two electrodes 200 located on the same base plate 110. Therefore, when manufacturing the protective cover 300, the two protective units 310 can be integrally formed according to the pre-determined design dimensions. Specifically, when the protective cover 300 is made of a material such as plastic, the protective cover 300 can be produced using an integral molding process such as an injection molding process, thereby completing an integral molding arrangement between the two protective units 310.

For example, two adjacent protective units 310 are detachably connected.

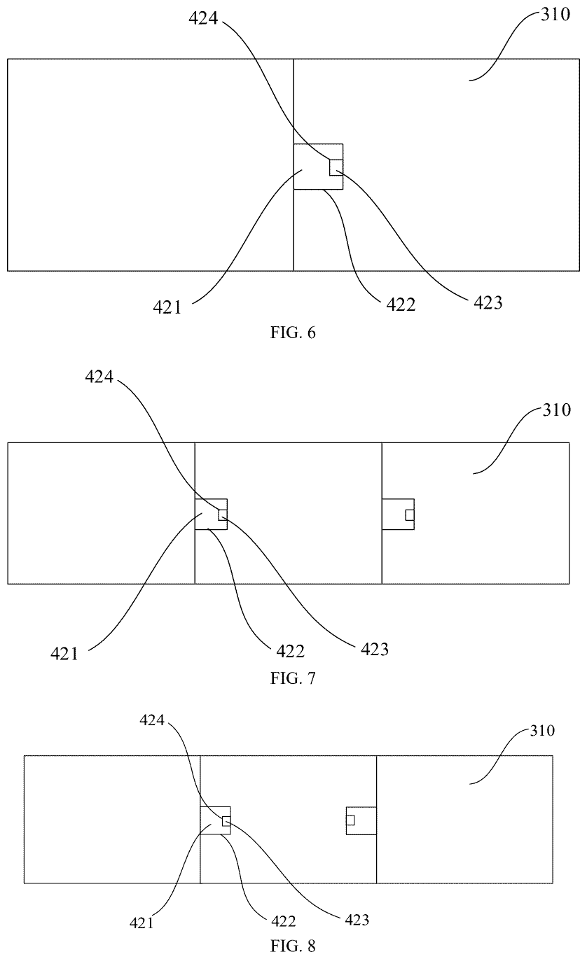

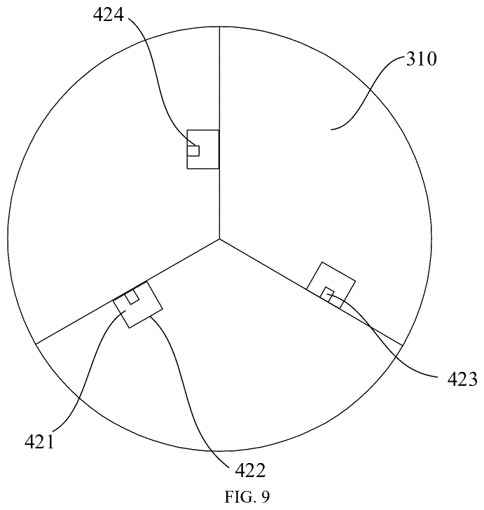

Referring to FIGS. 6 to 9, in some embodiments of the present application, two adjacent protective units 310 are connected by sliding to form the protective cover 300. Specifically, a sliding protrusion 421 can be provided on one side of one protective unit 310 along its length direction, while a sliding groove 422 can be provided at the other protective unit 310 along its length direction. The sliding protrusion 421 is engaged with the sliding groove 422 to complete the connection between the two protective units 310. Further optimization of the sliding protrusion 421 and the sliding groove 422 is also possible. For example, positioning protrusions 423 are provided on opposite sides of the sliding protrusion 421, and positioning grooves 424 are provided on opposite side walls of the sliding groove 422. In this way, when the sliding protrusion 421 is embedded in the sliding groove 422, the positioning protrusion 423 is also embedded in the positioning groove 424, and the positioning protrusion 423 slides in the positioning groove 424 as the sliding protrusion 421 slides in the sliding groove 422. Alternatively, the positioning protrusion 423 can also be provided at a side wall of the sliding groove 422, and the positioning groove 424 adapted to the positioning protrusion 423 is provided at the sliding protrusion 421. When the sliding protrusion 421 slides in the sliding groove 422, the positioning protrusion 423 also slides in the positioning groove 424.

In addition, the above-mentioned cooperation between the positioning protrusion 423 and the positioning groove 424 can be used to further improve the connection tightness between the two protective units 310. For example, the positioning protrusion 423 can be interference fit with the positioning groove 424, and the positioning protrusion 423 and the positioning groove 424 can be respectively provided at the top of the sliding protrusion 421 and the sliding groove 422. In this way, as the sliding protrusion 421 slides in the sliding groove 422, the positioning protrusion 423 will gradually embed into the positioning groove 424, thereby completing the interference fit between the two, and improving the connection tightness between the two protective units 310. It should be further explained that, with the sliding direction between the protective units 310 as a reference, the cross-sectional area of the positioning groove 424 can be fixed while the cross-sectional area of the positioning protrusion 423 gradually increases in the sliding direction, or the cross-sectional area of the positioning protrusion 423 can be fixed while the cross-sectional area of the positioning groove 424 gradually decreases in the sliding direction, or the cross-sectional area of the positioning groove 424 can be smaller than the cross-sectional area of the positioning protrusion 423.

It should be further explained that the specific number of the sliding protrusions 421, the sliding grooves 422, the positioning protrusions 423 and the positioning grooves 424 can be selected according to factors such as the actual installation strength requirements. For example, the positioning protrusions 423 are provided on the opposite sides of the sliding protrusion 421, and the positioning grooves 424 are provided on the opposite side walls of the sliding groove 422, or two sliding protrusions 421 are provided at one protective unit 310, and two sliding grooves 422 are provided at the other protective unit 310. The number of sliding protrusions 421 can be three, four, or even more. The number of the sliding grooves 422 may be equal to the number of the sliding protrusions 421. The number of the positioning protrusions 423 may be three, four, or even more. The number of the positioning grooves 424 may also be equal to the number of the positioning protrusions 423.

The number of sliding protrusions 421 and the number of sliding grooves 422 are not necessarily equal. For example, one protective unit 310 is provided with only one sliding protrusion 421, while the other protective unit 310 is provided with a plurality of sliding grooves 422. The sliding protrusion 421 can be selected to slide into a certain sliding groove 422 according to the relative position between the two electrodes 200. The two can also be interchanged, for example, one protective unit 310 is provided with only one sliding groove 422, while the other protective unit 310 is provided with a plurality of sliding protrusions 421. The sliding protrusion 421 can be selected to slide into the sliding groove 422 according to the relative position between the two electrodes 200. In addition, two sliding protrusions 421 can be provided at one protective unit 310, three sliding grooves 422 can be provided at the other protective unit 310, and the spacing between the two sliding protrusions 421 is equal to the spacing between two adjacent sliding grooves 422, that is, the two sliding protrusions 421 can choose any two adjacent sliding grooves 422 to slide into. Similarly, the number of sliding protrusions 421 can be three, four, or even more, and the number of sliding grooves 422 can also be two, three, four, or even more.

According to the above description, the cooperation between the positioning protrusion 423 and the positioning groove 424 can also be one to many, many to one, or even many to many. For example, one positioning protrusion 423 corresponds to two, three, or even more positioning grooves 424; one positioning groove 424 corresponds to two, three, or even more positioning protrusions 423; a plurality of positioning grooves 424 correspond to a plurality of positioning protrusions 423, and the number of positioning grooves 424 and positioning protrusions 423 is not necessarily the same.

It should be further explained that if the protective unit 310 is made of a relatively soft material, that is, after the protective unit 310 is sleeved at the electrode 200, it can still rotate within a certain range with the electrode 200 as the axis, and the length direction of the above-mentioned sliding protrusion 421 and the sliding groove 422, and the positioning protrusion 423 and the positioning groove 424 can be perpendicular to the length direction of the protective unit 310. In this case, during installation, the protective unit 310 is first sleeved at the electrode 200, and then slightly rotated so that the sliding protrusion 421 is matched with the sliding groove 422, and the positioning protrusion 423 is matched with the positioning groove 424. Alternatively, the deformation ability of the protective unit 310 can be utilized to make the length directions of the above-mentioned sliding protrusion 421 and the sliding groove 422, and the positioning protrusion 423 and the positioning groove 424 inclined to the length direction of the protective unit 310. That is, when the protective unit 310 is sleeved at the electrode 200, the protective unit 310 is first deformed, so that the sliding protrusion cooperates with the sliding groove 422, and the positioning protrusion 423 cooperates with the positioning groove 424, thereby completing the connection between the two protective units 310.

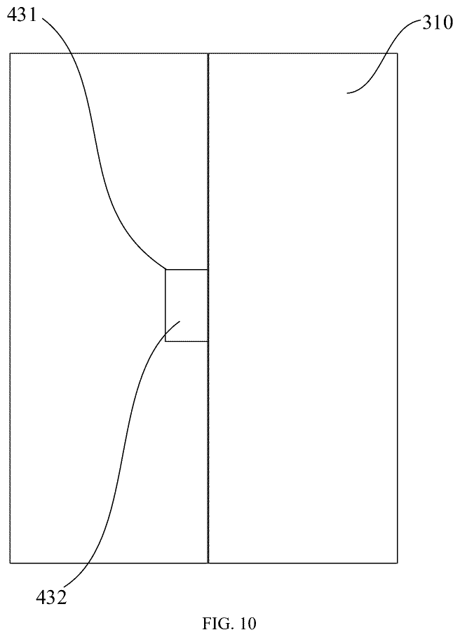

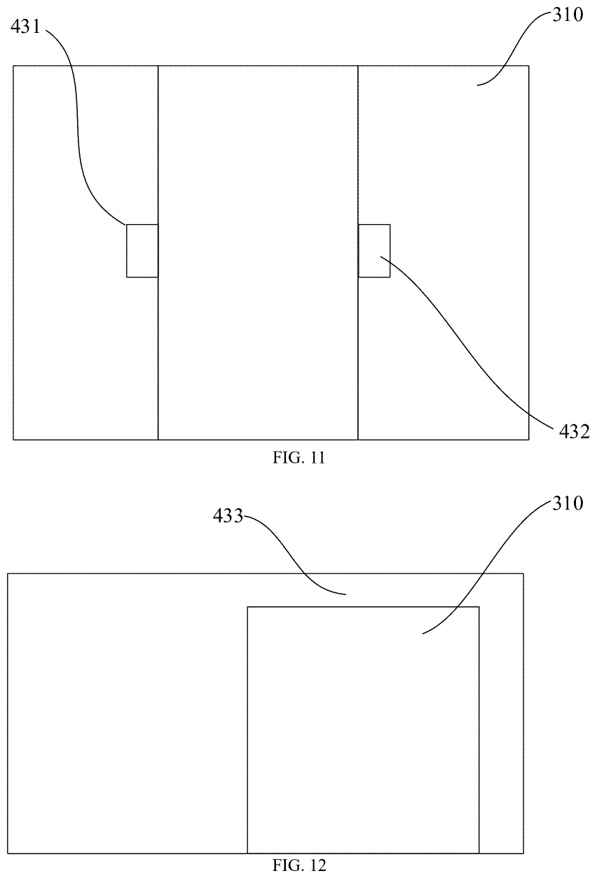

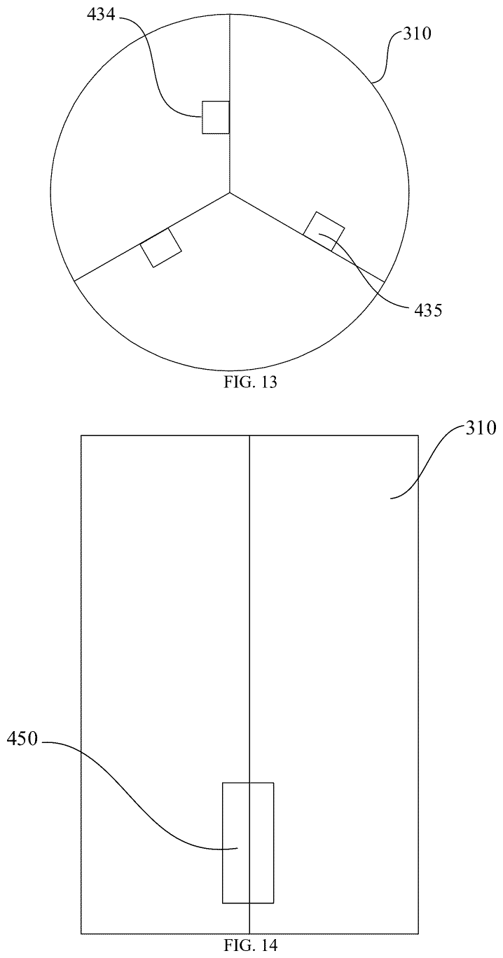

Referring to FIGS. 10 to 13, in some embodiments of the present application, two protective units 310 are buckled together to form the protective cover 300. Specifically, one protective unit 310 may be recessed to form a fastening groove 431, while a fastening portion 432 is formed to protrude from the other protective unit 310. When the two protective units 310 are respectively sleeved at the electrode 200, the fastening portion 432 is embedded in the fastening groove 431. It should be noted that if there is a higher connection strength requirement between the two protective units 310, the fastening portion 432 should be interference fit with the fastening groove 431 to ensure the connection stability between the two protective units 310. If the required connection strength between the two protective units 310 is lower, the fastening portion 432 can be adapted to the fastening groove 431. Alternatively, after the fastening portion 432 is engaged with the fastening groove 431, the fastening portion 432 can swing in the fastening groove 431, depending on actual use and design requirements.

There are other implementations of the fastening method of the two protective units 310. For example, one side of one protective unit 310 is extended and bent to form a fastening body 433, and the other protective unit 310 is entirely embedded in the fastening body 433, which can be understood that one protective unit 310 is buckled to the portion formed by extending the other protective unit 310. For another example, both protective units 310 are extended to form a fastening portion 432, but the fastening portion 432 of one protective unit 310 is provided with a fastening groove 434, and the fastening portion 432 of the other protective unit 310 is provided with a fastening protrusion 435. When the two protective units 310 are respectively sleeved at the two electrodes 200, the fastening protrusion 435 will cooperate with the fastening groove 434, thereby completing the connection between the two protective units 310. The specific configuration of the fastening portion 432 can be determined according to actual usage requirements. That is, the number of fastening grooves 434 and the number of fastening protrusions 435 can be changed according to actual usage requirements, and the numbers of the two are not required to be equal. For example, one fastening groove 434 may correspond to multiple fastening protrusions 435, or one fastening protrusion 435 may correspond to multiple fastening grooves 434, or three fastening protrusions 435 may correspond to five fastening grooves 434, and vice versa. However, it should be noted that since there are multiple fastening grooves 434 corresponding to multiple fastening protrusions 435, and the number of the two may be not equal, it is necessary to reasonably set the spacing between the fastening grooves 434 and the spacing between the fastening protrusions 435 to avoid deviation, which may cause the fastening between the two protective units 310 to fail to be completed.

It is worth noting that, when multiple fastening grooves 434 correspond to multiple fastening protrusions 435, there are a variety of design possibilities for the spacing between the fastening grooves 434 and the spacing between the fastening protrusions 435. For example, five fastening grooves 434 correspond to two fastening protrusions 435. At this time, when both the two fastening protrusions 435 can be fastened to the corresponding fastening grooves 434, the total length of the two fastening protrusions 435 and the spacing between them can be equal to the total length of the three fastening grooves 434 and the spacing between them. That is, when the two fastening protrusions 435 are combined with the fastening grooves 434, there must be a fastening groove 434 between the two fastening protrusions 435. The matching of the fastening protrusion 435 and the fastening groove 434 can be selected according to the actual arrangement of the electrode 200.

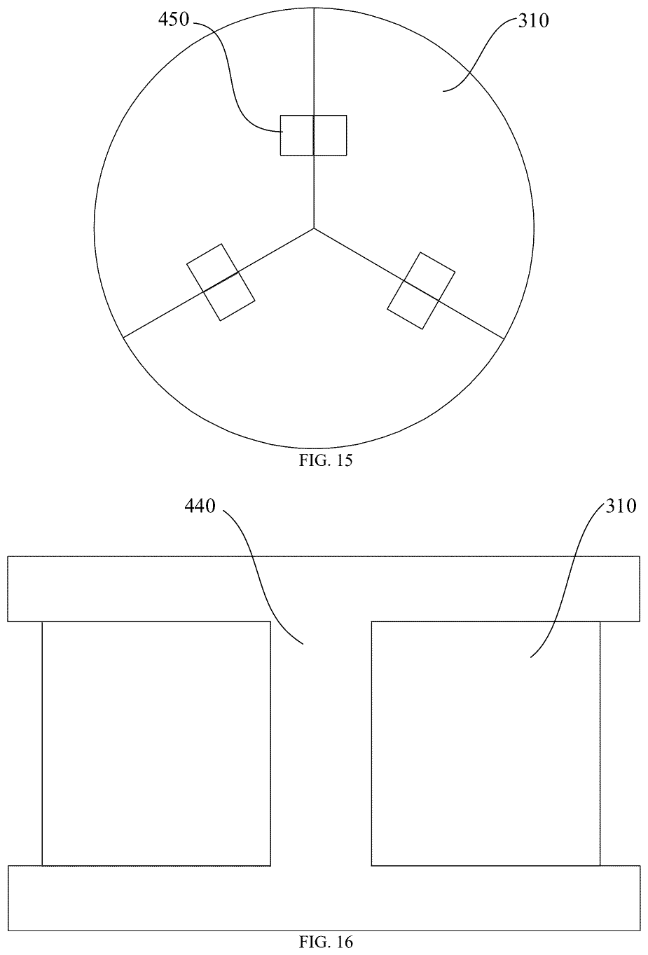

Referring to FIGS. 14 and 15, in some embodiments of the present application, the two protective units 310 can be connected by magnetic attraction. Specifically, magnets 450 can be respectively provided at the two protective units 310, and the two magnets 450 can attract each other when the two protective units 310 are respectively sleeved at the electrodes 200. Thus, when the two protective units 310 are respectively sleeved at the two electrodes 200, the two magnets 450 will attract each other, so that the two protective units 310 are tightly fitted together under the influence of magnetic force, thereby completing the connection between the two protective units 310.

Accordingly, one or more magnets 450 may be provided at the protective unit 310, and the magnetic poles of each magnet 450 may be set according to actual use needs. For example, two protective units 310 are each provided with two magnets 450, and the two magnets 450 on a single protective unit 310 have opposite magnetic poles. The magnetic poles of the magnets 450 on the two protective units 310 correspond one to one. For example, a magnet 450 is provided at each of the upper and lower ends of one protective unit 310, with the magnet 450 at the upper end being an s-pole and the magnet 450 at the lower end being an n-pole. Another protective unit 310 is also provided with magnets 450 at its upper and lower ends, but the magnet 450 at the upper end of this protective unit 310 is an n-pole, and the magnet 450 at the lower end is an s-pole. Therefore, when the two protective units 310 are brought close to each other, they are tightly attached together under the action of the magnets 450 and cannot be reversed. For another example, multiple magnets 450 can be provided at one protective unit 310, and multiple magnets 450 can also be provided at another protective unit 310. The number of the two is not necessarily equal, but the magnets 450 between the two are of opposite poles, so that they can attract each other. The corresponding position of each magnet 450 can be selected according to actual usage requirements to complete the connection between the protective units 310.

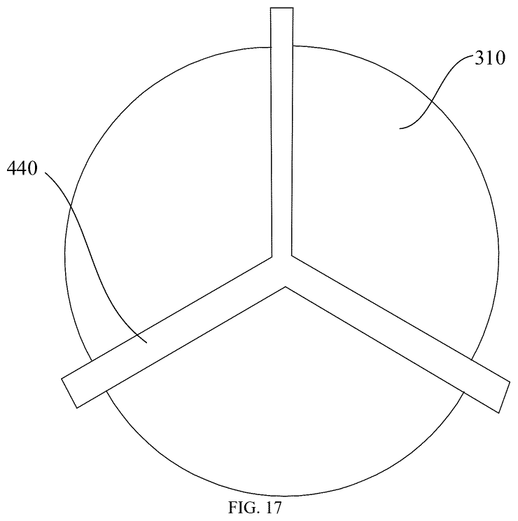

Referring to FIGS. 16 and 17, in some embodiments of the present application, the two protective units 310 may be connected by other additional connection members 440. For example, a [symbol] -shaped connection member 440 is provided between the two protective units 310, and the connection member 440 has a columnar body with mounting grooves provided on opposite sides of the body to form the [symbol] -shape. The two protective units 310 are respectively embedded in the two mounting grooves, thereby completing the connection between the two protective units 310.

It should be noted that the provision of the connection member 440 is not limited to the above-mentioned form. The connection member 440 can be a connecting ring, and a connecting groove for the connecting ring to be embedded can be provided on the outer side of the two protective units 310. The connecting ring itself has a certain elasticity, so that the connecting ring can be sleeved at the two protective units 310, and then the elasticity of the connecting ring itself is used to complete the connection of the two protective units 310. The connection member 440 can also be a connecting rod, and a connecting groove for the end of the connecting rod to be embedded is provided on the outer side of the two protective units 310. The connecting rod is embedded in the connecting groove, thereby completing the connection of the two protective units 310.

For another example, two adjacent protective units 310 are movably connected.

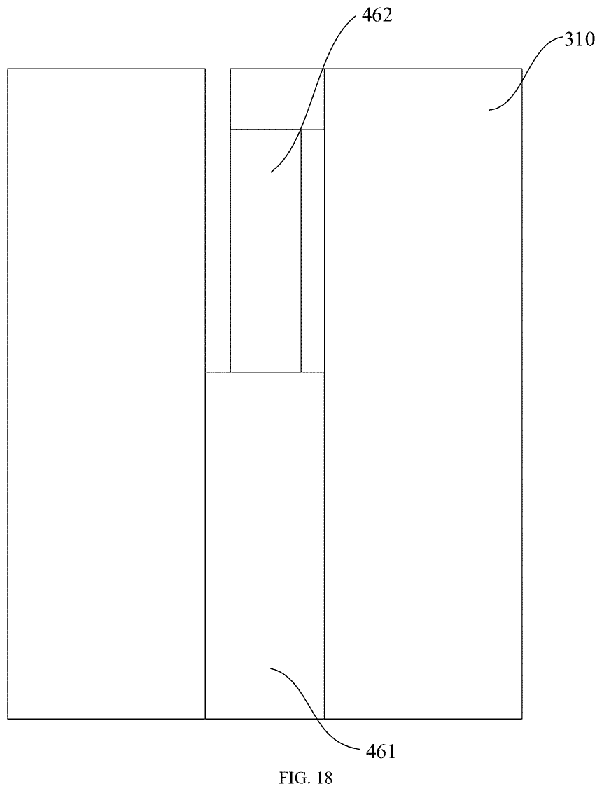

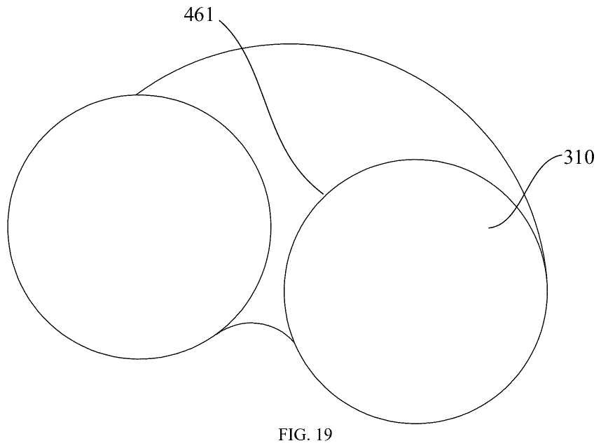

Referring to FIGS. 18 and 19, in some embodiments of the present application, the two protective units 310 are rotatably connected. For example, a rotation groove 461 is provided at one protective unit 310, while a rotation shaft 462 is provided at the other protective unit 310. When the two protective units 310 are sleeved at the electrode 200, the rotation shaft 462 is inserted into the rotation groove 461 and can rotate in the rotation groove 461, thereby completing the rotational connection between the two protective units 310. It should be noted that in some extremely special cases, the two protective units 310 may be connected rotatably by hinges, but hinges are generally made of insulating materials.

In addition, in addition to utilizing the cooperation between the rotation shaft 462 and the rotation groove 461 to achieve the rotational connection between the two protective units 310, other forms can also be used to achieve the relative rotation between the two protective units 310. For example, a rotation groove 461 is formed by extending from the outer side of the protective unit 310, and the other protective unit 310 is rotationally connected in the rotation groove 461, thereby completing the connection between the two protective units 310.

Based on the above, when three or more electrodes 200 are provided, three or more protective units 310 are also provided at the protective cover 300. The connection method described above can be used between the three or more protective units 310, but variations may be made as the number of protective units 310 increases. The following uses three protective units 310 as an example for a specific description.

First, when the three electrodes 200 are arranged on the same straight line.

Referring to FIGS. 3 to 5, if the three protective units 310 are fixedly connected, a connection rib 410 may be provided between two adjacent protective units 310. The number of connection ribs 410 may be one or more, and may be selected based on the required connection strength between the two adjacent protective units 310. The connection rib 410 may be in the shape of a bar, i.e., both ends of the connection rib 410 are connected to the two adjacent protective units 310 respectively. The connection rib 410 can also be made into a plate shape, that is, the opposite sides of the connection rib 410 are respectively connected to the two adjacent protective units 310. In addition, with the front view direction of the connection rib 410 as a reference, the connection rib 410 can also be in a regular shape such as a hexagon, and the two adjacent protective units 310 are respectively connected to the opposite sides or both sides of the connection rib 410. The projection of the connection rib 410 in the front view direction can be a regular shape such as a rectangle and a square, or an irregular shape. The number of connection ribs 410 can be one, two, three or four, and can be selected according to actual conditions. During installation, the three protective units 310 can be installed as a whole, that is, the three protective units 310 are respectively sleeved at the three electrodes 200 at the same time. The protective units 310 can also be connected by gluing, that is, two adjacent protective units 310 are connected by gluing. The two adjacent protective units 310 may be pre-glued together when they are sleeved at the electrode 200, or may be glued together after they are sleeved at the electrode 200. It should be noted that the type of glue used for gluing is not limited, as long as it maintains good stability in the refrigerant or oil. In addition, hot melt adhesive may be used to connect the two protective units 310, that is, the two adjacent protective units 310 may be glued together using hot melt adhesive in advance. When the protective unit 310 is made of a thermoplastic material such as rubber or plastic, the properties of the material itself can also be utilized for bonding; that is, heating is used to weld the contact surfaces of two adjacent protective units 310, thereby completing the bonding between the two adjacent protective units 310.

In the present application, for example, the three protective units 310 are integrally formed into the protective cover 300 as a whole, that is, the three protective units 310 are directly integrally formed and fixed to each other, without the need for other structures to establish a connection relationship between the three protective units 310. Similarly, the size of a single protective unit 310 and the size of the protective cover 300 as a whole can be designed in advance according to the spacing between the three electrodes 200, and then the protective cover 300 is produced and processed using an integrated molding process. For example, when the protective cover 300 is made of plastic, the injection molding process is used to produce the protective cover 300, thereby obtaining an integrated protective cover 300.

Referring to FIGS. 6 to 9, when the three protective units 310 are detachably connected, referring to the above description of the sliding connection between two adjacent protective units 310, the sliding groove 422 and the sliding protrusion 421 can be respectively provided on the opposite sides of the protective units 310, that is, the sliding groove 422 of the protective unit 310 is adapted to the sliding protrusion 421 of one protective unit 310, and the sliding protrusion 421 of the protective unit 310 is adapted to the sliding groove 422 of another protective unit 310, thereby completing the sliding connection between the three protective units 310. Furthermore, according to the above description of the sliding connection between two adjacent protective units 310, the arrangement of the positioning protrusions 423 and the positioning grooves 424 may also be changed accordingly. For example, the positioning groove 424 are provided in the sliding groove 422 of the protective unit 310, and the positioning protrusion 423 are provided at the sliding protrusion 421 of this protective unit 310. The positioning protrusion 423 of one protective unit 310 is embedded in the positioning groove 424 of the other protective unit 310, and then the positioning protrusion 423 of the other protective unit 310 is embedded in the positioning groove 424 of this protective unit 310. The specific matching relationship, position, quantity and shape of the sliding protrusion 421, the sliding groove 422, the positioning protrusion 423 and the positioning groove 424 can be changed by referring to the above description of the sliding connection between two adjacent protective units 310.

Referring to FIGS. 10 to 13, and referring to the above description regarding the fastening between the two protective units 310, the fastening groove 431 and the fastening portion 432 may be provided on the opposite sides of the protective unit 310. For example, when the fastening portion 432 of one protective unit 310 is buckled into the fastening groove 431 of another protective unit 310, the fastening portion 432 of the other protective unit 310 is then buckled into the fastening groove 431 of this protective unit 310. Alternatively, opposite sides of one of the three protective units 310 may be extended and bent to form the fastening bodies 433, and the other two protective units 310 of the three protective units 310 may be respectively embedded into the fastening bodies 433 on the opposite sides of the one protective unit 310. Alternatively, two of the three protective units 310 may be formed with the fastening bodies 433, and one protective unit 310 provided with the fastening body 433 may be embedded into the fastening body 433 of the other protective unit 310, and the remaining one of the three protective units 310 may be embedded into the fastening body 433 of the protective unit 310. In addition, the protective unit 310 can be extended to form the fastening portion 432, and a fastening groove 434 or a fastening protrusion 435 may be formed at the fastening portion 432, thereby completing the fastening. The number and corresponding settings of the fastening grooves 434 and the fastening protrusion 435 may refer to the above description of the fastening between the two protective units 310.

Referring to FIGS. 14 and 15, and referring to the above description of the magnetic attraction between the two protective units 310, magnets 450 may be provided on opposite sides of each protective unit 310, and the magnetic poles of the magnets 450 on the opposite sides are oriented in the same direction, that is, one magnet 450 is oriented toward the n-pole, and the other magnet 450 is oriented toward the s-pole. Since the two magnets 450 are located on the opposite sides of the protective unit 310, when the magnetic poles of the two magnets 450 are oriented in the same direction, the magnetic poles displayed by the two magnets 450 on the opposite sides of the protective unit 310 are opposite. Thus, the three protective units 310 can be combined in pairs to complete the connection; and the specific number and position of the magnets 450 on each protective unit 310 can be reasonably changed with reference to the above description of the magnetic attraction between the two protective units 310.

Referring to FIGS. 16 and 17, and referring to the above description of the connection member 440, two connection members 440 may be provided between the three protective units 310, that is, a [symbol] -shaped connection member 440 is provided between two adjacent protective units 310. The connection member 440 has a columnar body with installation grooves formed on the opposite sides of the body to form an [symbol] -shape. The two protective units 310 are respectively embedded in the two installation grooves. It should be noted that, among the three protective units 310, the protective unit 310 located in the middle is embedded in the installation grooves of the two connection members 440 at the same time, that is, the opposite installation grooves of the two connection members 440 will surround the protective unit 310 located in the middle, thereby completing the connection of the three protective units 310.

The specific configuration of the connection member 440 is also not limited to the above-mentioned form. The connection member 440 can be provided with three installation grooves, and the three protective units 310 may be respectively and simultaneously embedded in the three installation grooves of the connection member 440. The connection member 440 may also be a connecting ring, and the outer sides of the three protective units 310 can each be provided with a connecting groove for the connecting ring to be embedded. The connecting ring itself has a certain degree of elasticity, so that the connecting ring can be sleeved at the three protective units 310, and then the elasticity of the connecting ring itself is used to complete the connection of the three protective units 310. The connection member 440 can also be a connecting rod. The outer sides of the three protective units 310 are all provided with connecting grooves for the ends of the connecting rods to be embedded. The two connecting rods are respectively embedded in the connecting grooves on the two adjacent protective units 310, thereby completing the connection of the three protective units 310.

Referring to FIGS. 18 and 19, when the three protective units 310 are movably connected, referring to the above description of the rotational connection between two protective units 310, a rotation groove 461 and a rotation shaft 462 are respectively provided on both sides of each protective unit 310. When the rotation shaft 462 of one protective unit 310 is embedded in the rotation groove 461 of another protective unit 310, the rotation shaft 462 of yet another protective unit 310 will be embedded in the rotation groove 461 of this protective unit 310, thereby completing the rotational connection between the three protective units 310. Correspondingly, the protective unit 310 located in the middle may be provided with rotation shafts 462 on both sides, while the other two protective units 310 may be provided with rotation grooves 461 on the side facing the protective unit 310. Alternatively, the protective unit 310 located in the middle may be provided with rotation grooves 461 on both sides, while the other two protective units 310 may be provided with rotation shafts 462 on the side facing the protective unit 310, which can also complete the rotational connection between the three protective units 310.

It should be noted that other forms can also be used to achieve the relative rotation between the three protective units 310. For example, a rotation groove 461 is formed by extending from the opposite sides of the protective unit 310 located in the middle, and the other two protective units 310 are respectively rotatably connected in the two rotation grooves 461, thereby completing the rotational connection between the three protective units 310.

The above are examples of the connection methods between the protective units 310 when three electrodes 200 are provided. Without violating the principles, each example can be changed accordingly to complete the connection between the protective units 310. Such embodiments will not be repeated, but the unrecorded changes should also be regarded as the scope recorded and disclosed in some embodiments. In addition, when the number of electrodes 200 is greater than three and multiple electrodes 200 are arranged on the same straight line, the connection methods between the protective units 310 can be changed accordingly with reference to the above examples. Without violating and changing the relevant principles, each change should also be regarded as the scope recorded and disclosed in some embodiments.

Secondly, the three electrodes 200 are arranged in a triangular pattern, or in a “ha” shape.

If the three protective units 310 are fixedly connected, then any two of the three protective units 310 are adjacent. Referring again to the above description regarding the fixed connection between the three protective units 310, and referring to FIGS. 3 to 5, a connection rib 410 can be provided between two adjacent protective units 310. The number of connection ribs 410 can be one or more, depending on the required connection strength between the two adjacent protective units 310. The connection rib 410 can be in the form of a bar, with both ends of the connection rib 410 connected to the two adjacent protective units 310. The connection rib 410 can also be made into a plate shape, that is, the opposite sides of the connection rib 410 are respectively connected to the two adjacent protective units 310. In addition, with the front view direction of the connection rib 410 as a reference, the connection rib 410 can also be in the shape of a regular shape such as a hexagon, and the two adjacent protective units 310 are respectively connected to the opposite sides or both sides of the connection rib 410. The projection of the connection rib 410 in the front view direction can be a regular shape such as a rectangle and a square, or an irregular shape. The number of connection ribs 410 can be one, two, three or four, etc., which can be selected according to actual conditions. During installation, the three protective units 310 can be installed as a whole, that is, the three protective units 310 are respectively sleeved at the three electrodes 200 at the same time. Combined with the above description, the projection of the connecting rib 410 can also be a regular shape such as a triangle or a pentagon, that is, the connecting rib 410 connects the three protective units 310 at the same time. Taking the projection of the connecting rib 410 as a triangle as an example, the connecting rib 410 can be in the shape of a triangular plate, a triangular pyramid, a triangular prism, etc. When the connection rib 410 is in the shape of a triangular plate, it has three sides, which are respectively connected to the outer walls of the three protective units 310. When the connection rib 410 is in the shape of a triangular pyramid, the three protective units 310 can be respectively connected to the three sides of the bottom surface of the connection rib 410. When the connection rib 410 is in the shape of a triangular prism, it has three side walls, and the three protective units 310 are respectively connected to the three side walls. The above is an example of the connection rib 410.

Alternatively, the three protective units 310 may be connected by gluing, that is, two adjacent protective units 310 may be connected by gluing. The two adjacent protective units 310 may be pre-glued when they are sleeved at the electrode 200, or may be glued after they are sleeved at the electrode 200. It should be noted that the type of glue used for gluing is not limited, as long as it maintains good stability in refrigerant or oil. In addition, hot melt adhesive may be used to connect the two protective units 310, that is, the two adjacent protective units 310 can be glued together using hot melt adhesive in advance. When the protective unit 310 is made of a thermoplastic material such as rubber or plastic, the properties of the material itself can also be used for bonding; that is, heating is used to weld the contact surfaces of two adjacent protective units 310, thereby completing the bonding between the two adjacent protective units 310. It should be noted that the shape of the protective unit 310 can be reasonably set so that the three protective units 310 form a whole after being glued together.

In the present application, the three protective units 310 can be integrally formed into the protective cover 300 as a whole, that is, the three protective units 310 are directly integrally formed and fixed to each other, without the need for other structures to establish a connection relationship between the three protective units 310. It should be noted that when the three electrodes 200 are arranged in a triangle, using an integral molding method to make the protective cover 300 is a better solution, which can effectively reduce the assembly steps and assembly difficulty.

When the three protective units 310 are detachably connected, referring to FIGS. 6 to 9 and the above description of the sliding connection of the three protective units 310, considering the restrictions on the overall shape of the protective unit 310 caused by the arrangement of the three electrodes 200, the protective unit 310 can be initially designed as a solid body with two sides, such as a triangular prism, a quadrangular prism, a pentagonal prism, or other shapes. The sliding groove 422 and the sliding protrusion 421 are respectively provided on two sides of one protective unit 310 adjacent to the other two protective units 310. That is, the sliding groove 422 of this protective unit 310 is adapted to the sliding protrusion 421 of one protective unit 310, and the sliding protrusion 421 of this protective unit 310 is adapted to the sliding groove 422 of the other protective unit 310, thereby completing the sliding connection between the three protective units 310. Based on the above description of the sliding connection among the three protective units 310, the arrangement of the positioning protrusion 423 and the positioning groove 424 can also be modified accordingly. For example, the positioning groove 424 is provided in the sliding groove 422 of the protective unit 310, and the positioning protrusion 423 is provided at the sliding protrusion 421 of this protective unit 310. The positioning protrusion 423 of one protective unit 310 is embedded in the positioning groove 424 of another protective unit 310, and then the positioning protrusion 423 of yet another protective unit 310 is embedded in the positioning groove 424 of this protective unit 310. The specific matching relationship, position, number and shape of the sliding protrusion 421, the sliding groove 422, the positioning protrusion 423 and the positioning groove 424 can be changed with reference to the above description of the sliding connection of the three protective units 310. It should be noted that, further considering the impact of the arrangement of the three electrodes 200 on the overall shape of the protective unit 310, it is also possible that one protective unit 310 is provided with only a sliding groove 422, and the other two protective units 310 are provided with sliding protrusions 421 on the side surfaces adjacent to the one protective unit 310, vice versa. One of the positioning protrusions 423 and the positioning groove 424 can be provided at one protective unit 310 and the other of the positioning protrusion 423 and the positioning groove 424 is provided at the other two protective units 310. Further, they can also be provided separately to form a variety of combinations, and various changes can be made without changing the principle and violating common sense.

With reference to the above description of the fastening between the three protective units 310, referring to FIGS. 10 to 13, the fastening groove 431 and the fastening portion 432 can be respectively provided on two sides of one protective unit 310 adjacent to the other two protective units 310. For example, when the fastening portion 432 of one protective unit 310 is buckled into the fastening groove 431 of another protective unit 310, and the fastening portion 432 of yet another protective unit 310 is then buckled into the fastening groove 431 of this protective unit 310. Alternatively, one of the three protective units 310 can be extended and bent on two sides adjacent to the other two protective units 310 to form the fastening body 433, and the other two protective units 310 can be respectively embedded in the fastening bodies 433 on both sides of the protective unit 310. Alternatively, two of the three protective units 310 may be formed with a fastening body 433, and the protective unit 310 may be embedded in the fastening bodies 433 of the two protective units 310 at the same time. Alternatively, the fastening portion 432 may be formed by extending from the protective unit 310, and the fastening groove 434 or the fastening protrusion 435 may be formed at the fastening portion 432 to complete the fastening. Further, considering the impact of the arrangement of the three electrodes 200 on the overall shape of the protective unit 310, the number and corresponding settings of the fastening grooves 434 and the fastening protrusions 435 may be varied in various ways without changing the principle or violating common sense.

Referring again to the above description of the magnetic attraction between the three protective units 310, combined with FIGS. 14 and 15, magnets 450 can be provided on both sides of each protective unit 310 adjacent to the other two protective units 310, and the magnetic poles of the magnets 450 on both sides are opposite to each other, that is, one magnet 450 is oriented toward the n pole, and the other magnet 450 is oriented toward the s pole. Since the two magnets 450 are located on both sides of the protective unit 310, the three protective units 310 can be combined in pairs to complete the connection. The specific number and position of the magnets 450 on each protective unit 310 can be reasonably changed with reference to the above description of the magnetic attraction between the three protective units 310.

Referring again to the above description of the connection member 440, combined with FIGS. 16 and 17, three connection members 440 can be provided between the three protective units 310, that is, a “ [symbol] ”-shaped connection member 440 is provided between two adjacent protective units 310. The connection member 440 has a columnar body with installation grooves on the opposite sides of the body to form the “ [symbol] ” shape. The two protective units 310 are respectively embedded in the two installation grooves. It should be noted that, considering the impact of the arrangement of the three electrodes 200 on the overall shape of the protective unit 310, the three protective units 310 are all embedded in the installation grooves of the two connection members 440 at the same time, that is, the opposite installation grooves of the two connection members 440 will surround the protective unit 310 located in the middle, thereby completing the connection of the three protective units 310.

The specific configuration of the connection member 440 is also not limited to the above-mentioned form. The connection member 440 may be provided with three installation grooves, and the three protective units 310 may be respectively and simultaneously embedded in the three installation grooves of the connection member 440. The connection member 440 may also be a connecting ring, and the outer sides of the three protective units 310 may each be provided with a connecting groove for the connecting ring to be embedded. The connecting ring itself has a certain degree of elasticity, so that the connecting ring can be sleeved at the three protective units 310, and then the elasticity of the connecting ring itself is used to complete the connection of the three protective units 310. The connection member 440 can also be a connecting rod. The outer sides of the three protective units 310 are all provided with connecting grooves for the ends of the connecting rods to be embedded. The two connecting rods are respectively embedded in the connecting grooves on the two adjacent protective units 310, thereby completing the connection of the three protective units 310.

When the three protective units 310 are movably connected, referring to the above description of the rotational connection between the three protective units 310, in conjunction with FIGS. 18 and 19, each protective unit 310 is provided with a rotation groove 461 and a rotation shaft 462 on both sides adjacent to the other protective units 310. When the rotation shaft 462 of one protective unit 310 is embedded in the rotation groove 461 of another protective unit 310, the rotation shaft 462 of yet another protective unit 310 is embedded in the rotation groove 461 of another protective unit 310, thereby completing the rotational connection between the three protective units 310. Considering the impact of the arrangement of the three electrodes 200 on the overall shape of the protective unit 310, the range of rotation between the three protective units 310 is extremely limited. Accordingly, the protective unit 310 is provided with a rotation shaft 462 on both sides, while the other two protective units 310 are provided with a rotation groove 461 on the side facing the protective unit 310. Alternatively, the protective unit 310 is provided with a rotation groove 461 on both sides, while the other two protective units 310 are provided with a rotation shaft 462 on the side facing the protective unit 310, in either case to achieve a rotational connection between the three protective units 310.

It should be noted that other forms can also be used to complete the relative rotation between the three protective units 310. For example, the rotation grooves 461 are formed by extending from the opposite sides of a protective unit 310, and the other two protective units 310 are respectively rotatably connected in the two rotation grooves 461, thereby completing the rotation connection between the three protective units 310.

The above are examples of the connection methods between the protective units 310 when three electrodes 200 are provided. Without violating the principles, each example can be changed accordingly to complete the connection between the protective units 310. Such embodiments will not be repeated, but the unrecorded changes should also be regarded as the scope recorded and disclosed in some embodiments. In addition, when the number of electrodes 200 is greater than three and multiple electrodes 200 are arranged in other shapes or styles, the connection methods between the protective units 310 can be changed accordingly with reference to the above examples. Without violating or changing the relevant principles, each change should also be regarded as the scope recorded and disclosed in some embodiments.

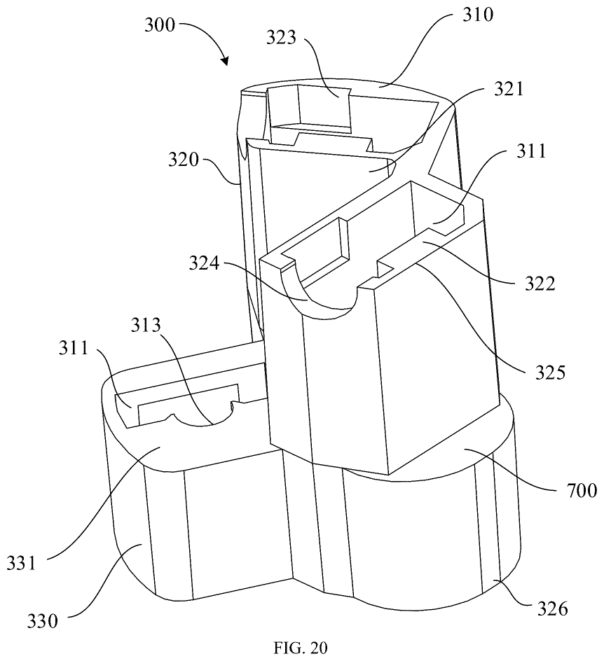

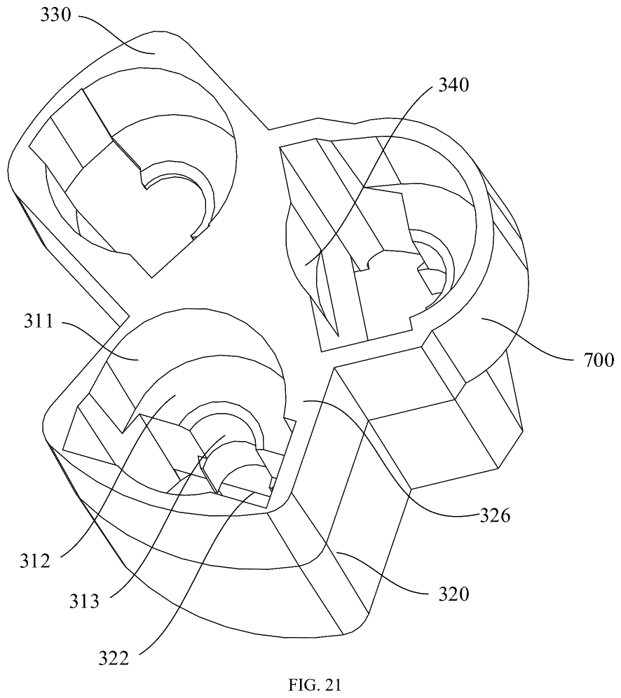

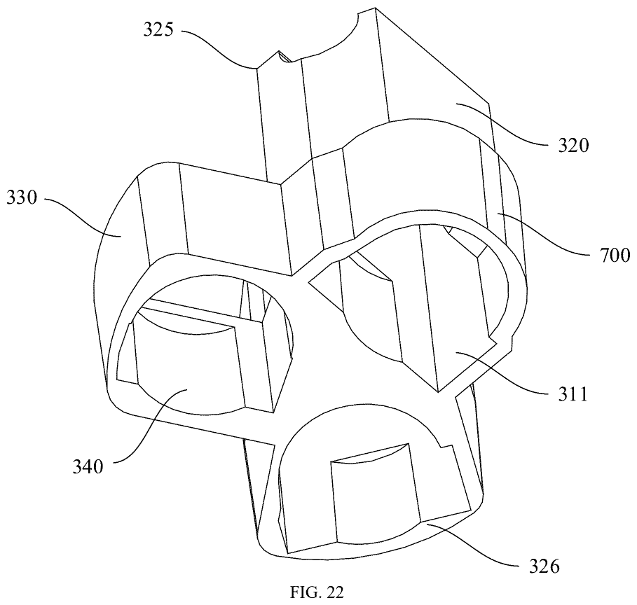

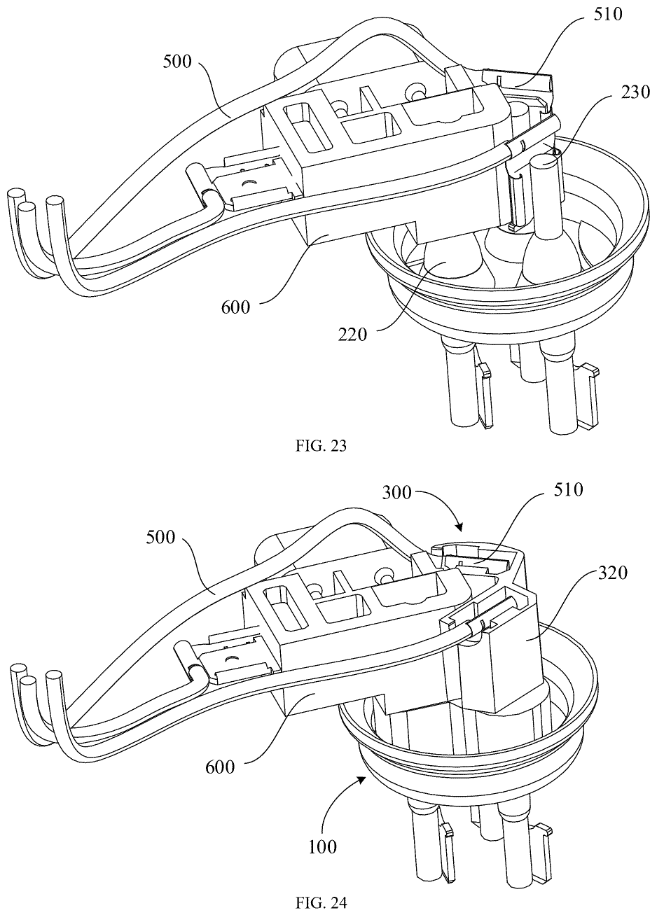

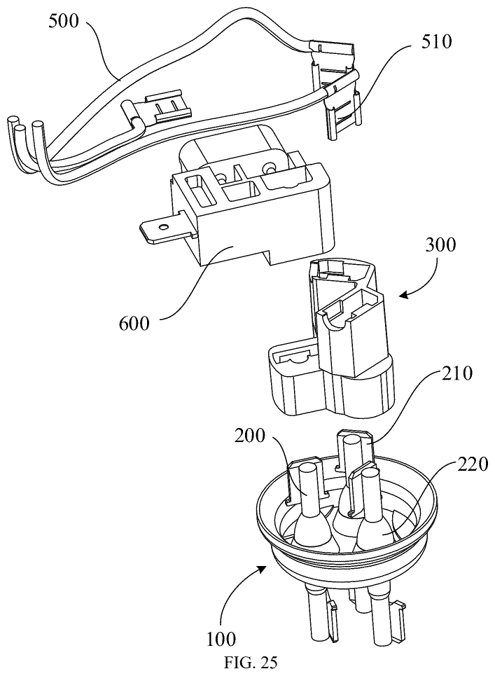

Referring to FIGS. 20 to 25, in some embodiments of the present application, the protective unit 310 is formed with a accommodation groove 311, and the accommodation groove 311 is used to receive the electrode 200. The cross-section of the accommodation groove 311 can be a regular shape, such as a polygon such as a triangle and a rectangle, or a variety of irregular shapes can be designed according to actual needs. The protective unit 310 is sleeved at the electrode 200 through the accommodation groove 311, thereby protecting the electrode 200 and reducing the possibility of metal debris adhering to the electrode 200 and causing a short circuit between the electrode 200 and the outer cover 100 or between the electrodes 200. In addition to being directly connected to the wire 500, the electrode 200 inside the compressor may also be connected to a protector 600 to reduce the possibility of overload of the circuit inside the compressor. The installation of the protector 600 requires that the electrode 200 has a certain length. Therefore, the protective unit 310 includes a first cylinder 320 and a second cylinder 330 of different lengths. The first cylinder 320 has a length greater than that of the second cylinder 330, and the first cylinder 320 completely accommodates the electrode 200 within the accommodation groove 311, further reducing the possibility of exposure of the electrode 200. The second cylinder 330 exposes the top of the electrode 200, that is, the protector 600 is connected to the electrode 200 with the second cylinder 330.

It should be noted that, in other cases, the lengths of the protective units 310 may also be the same. In combination with the above description of the first cylinder 320 and the second cylinder 330, the equal lengths of the protective units 310 can be approximately understood as the lengths of the protective units 310 being approximately equal to the length of the first cylinder 320 or the length of the second cylinder 330 when the lengths are equal, and the specific lengths of the protective units 310 can vary according to factors such as the length of the electrode 200 and design requirements. When the protective units 310 have the same length, the possibility of metal debris adhering to the electrode 200 along with the refrigerant or the oil can also be effectively reduced, thereby reducing the possibility of short circuits between the electrodes 200.

Taking the case where three electrodes 200 are arranged in a triangle as an example, only one protector 600 is generally provided, that is, one second cylinder 330 is provided, and the other two electrodes 200 are each provided with a protective unit 310 which is the first cylinder 320. The connection method between the second cylinder 330 and the two first cylinders 320 can refer to the above description of the connection method of the three protective units 310. In some embodiments, for example, the three protective units 310 are integrally formed.

However, it should be noted that when the electrode 200 needs to be connected to the protector 600, the second cylinder 330 is used for the protective unit 310. To facilitate the connection between the protector 600 and the electrode 200, the exposed length of the top of the electrode 200 with the second cylinder 330 is not less than 5 mm. It should be noted that the exposed length of the top of the electrode 200 refers to the length between the top surface of the electrode 200 and the top of the second cylinder 330. If the electrode 200 is connected to a general circuit device such as an electric wire 500, the first cylinder 320 can be used. Whether the second cylinder 330 is used on the electrode 200 is only related to whether the protector 600 is connected to the electrode 200, and has nothing to do with the number of electrodes 200.

Considering that high temperatures are generated when the outer cover 100 is secured to the compressor housing, and that these temperatures are generally higher than those generated when the electrodes 200 are energized, an isolation gap with a width not less than 0.1 mm is provided between the protective cover 300 and the surrounding plate 120 to prevent damage to the entire protective cover 300. In other words, the gap between each protective unit 310 and the surrounding plate 120 is not less than 0.1 mm. At this time, the reinforcement ribs 130 provided between the base plate 110 and the surrounding plate 120 also prevent direct contact between the protective cover 300 and the base plate 110, further reducing the possibility of damage to the protective cover 300 due to high temperatures.

To facilitate connection between the electrode 200 and circuit components such as the wire 500 or the protector 600, the electrode 200 is provided with electrode sheets 210, and the wire 500 or the protector 600 is provided with plug-in terminals 510 corresponding to the electrode sheets 200. During connection, the electrode sheet 200 is inserted into the plug-in terminal 510. Accordingly, in the first cylinder 320, to reduce the possibility of short circuit of the electrode 200 due to sticky metal debris, the electrode sheet 200s are completely enclosed in the accommodation groove 311. In the second cylinder 330, the electrode sheet 200 passes through the accommodation groove 311 along with the end of the electrode 200 to connect to the protector 600. Since the protector 600 has a certain volume, to facilitate the installation of the protector 600, an avoidance port 321 is provided between the two first cylinders 320 adjacent to the second cylinder 330, thereby facilitating the installation of the protector 600 and preventing the protector 600 from easily coming into contact with the first cylinder 320.

In order to reduce the possibility of the electrode 200 being exposed in the first cylinder 320, that is, to ensure that the electrode 200 is completely covered in the accommodation groove 311, a resistance portion 322 is formed to protrude from the inner wall of the accommodation groove 311 of the first cylinder 320. The resistance portion 322 abuts against the top surface of the electrode 200, thereby ensuring that the electrode 200 is completely provided in the accommodation groove 311. To prevent the resistance portion 322 from affecting the connection between the electrode sheet 200 and the plug-in terminal 510, the resistance portion 322 only abuts against part of the top surface of the electrode 200, thereby reducing the possibility of the resistance portion 322 interfering with the connection between the electrode sheet 200 and the plug-in terminal 510. In addition, to facilitate the installation of the wire 500, a wire groove 324 is provided on the end of the first cylinder 320, and the wire groove 324 is used to accommodate the wire 500. To facilitate the connection between the plug-in terminal 510 and the electrode sheet 200, a reserved slot 323 is also provided on the top of the first cylinder 320. The provision of the reserved slot 323 provides space for the connection between the plug-in terminal 510 and the electrode 200, thereby improving the convenience of the overall structure during installation.

To fix the protective unit 310 to the electrode 200, a fixation portion 312 is provided in the accommodation groove 311 of the first cylinder 320 and the second cylinder 330. The fixation portion 312 can abut against the electrode 200, thereby fixing the protective unit 310 to the electrode 200, reducing the possibility of the protective unit 310 falling off the electrode 200, and ensuring the protection of the electrode 200 by the protective unit 310. It should be noted that when the protector 600 is connected to the electrode 200, the second cylinder 330 can be stably fixed to the electrode 200 with the help of the cooperation between the protector 600 and the electrode 200, and the two first cylinders 320 connected to the second cylinder 330 are also stably fixed to the electrode 200. The provision of the fixation portion 312 further reduces the possibility of the protective cover 300 as a whole sliding on the electrode 200. Furthermore, to improve the fixing effect of the fixation portion 312, a notch groove is formed on the fixation portion 312, and the electrode 200 abuts against the wall of the arc-shaped notch groove 313 to complete the fixation. In some embodiments, the electrode 200 is cylindrical. To make the notch groove fit the outer peripheral wall of the electrode 200, the cross-section of the notch groove is arc-shaped. When the electrode 200 is a prism such as a triangular prism, a quadrangular prism, or a pentagonal prism, or other regular or irregular shapes, the cross-sectional shape of the notch groove may also be changed accordingly. For example, when the electrode 200 is in the shape of a triangular prism, the cross-sectional shape of the notch groove can be angular; when the electrode 200 is in the shape of a quadrangular prism, the cross-sectional shape of the notch groove can be angular or rectangular. The shape of the notch groove can change according to the specific shape of the electrode 200, and can fit with the electrode 200 to improve the fixing effect of the fixation portion 312 on the electrode 200.

The electrode 200 is provided with the electrode sheet 200, that is, after the overall structure is installed, the electrode sheet 200 and/or the plug-in terminal 510 directly abut against the wall of the accommodation groove 311, the electrode 200 abuts against the wall of the arc-shaped notch groove 313, and the top surface of the electrode 200 abuts against the resistance portion 322. The cooperation relationship of the above structure further reduces the possibility of the protective cover 300 sliding off or slipping from the electrode 200, thereby ensuring the protective effect of the protective cover 300 on the electrode 200.

It should be noted that, to maximize the use of space, to ensure that the protective cover 300 has a certain volume, and to reduce the difficulty of manufacturing and processing the protective cover 300, the protective unit 310 is sleeved at the insulator 220. To ensure the stability of the fixation between the protective unit 310 and the electrode 200, the cross-sectional area of the accommodation groove 311 cannot be too large. Therefore, an adapting groove 340 is formed at a side wall of the accommodation groove 311. The adapting groove 340 is used to expand the cross-sectional area of the bottom end of the accommodation groove 311, so that the insulator 220 can be covered in the accommodation groove 311 without affecting the stability of the fixation between the protective unit 310 and the electrode 200. In addition, since the electrode 200 is provided with electrode sheet 200s, and for the convenience of installation, the directions of the electrode sheet 200s are generally consistent, this may cause the cross-sectional area of the accommodation groove 311 of at least one of the three protective units 310 to be too small. Therefore, an accommodating portion 700 can be formed to protrude from the bottom of the protective unit 310, to expand the cross-sectional area of the accommodation groove 311, thereby ensuring the normal installation of the protective cover 300.

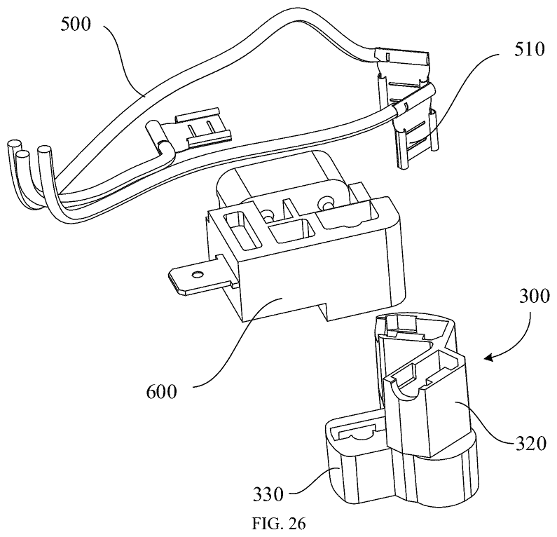

Referring to FIG. 26, the present application further describes a protection assembly, applied to the compressor. The protection assembly described in the present application includes at least one protector 600 and at least one protective cover 300. The protector 600 and the protective cover 300 may refer to the above description of the protector 600 and the protective cover 300. A plurality of electrodes 200 for electrical connection to the outside are provided in the compressor. The protector 600 is connected to the electrodes 200. The protective cover 300 includes a plurality of protective units 310. The number of the protective units 310 is not less than the number of the electrodes 200. The protective units 310 are sleeved at the electrodes 200, and the protective units 310 correspond to the electrodes 200 one by one. It should be noted that the connection between the protective units 3 can refer to the above description, and the structure of a single protective unit 310 can also refer to the above description.

It should be noted that the protective unit 310 can also be divided into a first cylinder 320 and a second cylinder 330 as described above. The first cylinder 320 is used to cover the entire electrode 200 as described above to reduce the possibility of metal debris adhering to the electrode 200, thereby reducing the possibility of short circuit between the electrode 200 and the housing or between the electrodes 200. As described above, the second cylinder 330 is also used to provide protection for the electrode 200 while leaving the top of the electrode 200 exposed to facilitate connection to the protector 600. However, it should be noted that, since different compressors may have different internal circuit configurations, the number of electrodes 200 may also be different, and thus the required number of protectors 600 may also be different. When at least one electrode 200 is provided at a certain position in the compressor, the number of protectors 600 may be selected as required, and then the number of first cylinders 320 and second cylinders 330 may be determined based on the number of protectors 600. The first cylinder 320 and the first cylinder 320, the first cylinder 320 and the second cylinder 330, or the second cylinder 330 and the second cylinder 330 may be connected, and the connection method may refer to the above description. The first cylinder 320 and the first cylinder 320, the first cylinder 320 and the second cylinder 330, or the second cylinder 330 and the second cylinder 330 can also be independent of each other, that is, a single first cylinder 320 or a single second cylinder 330 forms a protective cover 300. When at least one electrode 200 is provided at multiple positions in the compressor, the protector 600 and the protective cover 300 can also be provided to adapt in the same manner as described above.

It should be noted that since the protective cover 300 is sleeved at the electrode 200, the wires 500 and plug-in terminals 510 connected to the protector 600 or the electrode 200 can also be adaptively adjusted. That is, the wires 500 and plug-in terminals 510 can also be considered part of the protective assembly.

The present application also provides a compressor including the aforementioned electrode terminal. The specific structure of the electrode terminal refers to the aforementioned embodiments. Since this compressor adopts all the technical solutions of all the aforementioned embodiments, it has at least all the beneficial effects brought by the technical solutions of the aforementioned embodiments, which will not be repeated.

The present application also describes a refrigeration device, which includes the above-mentioned compressor and the electrode terminal. The specific structure of the electrode terminals refers to the above-mentioned embodiments. Since the compressor adopts all the technical solutions of all the above-mentioned embodiments, it has at least all the beneficial effects brought by the technical solutions of the above-mentioned embodiments, which will not be repeated here.

The above description are some embodiments of the present application and do not limit the scope of the present application. All equivalent structural transformations made using the contents of the specification and drawings of the present application under the inventive concept of the present application, or direct/indirect application in other related technical fields, are included in the scope of the present application.

1. An electrode terminal for a compressor, comprising:
an outer cover comprising a base plate and a surrounding plate connected to the base plate;
at least three electrodes passing through the base plate and insulated from the base plate; and
a protective cover comprising at least three protective units, wherein three protective units are respectively sleeved at the three electrodes.

2. The electrode terminal of claim 1, wherein two adjacent protective units are connected to each other.

3. The electrode terminal of claim 2, wherein two adjacent protective units are fixedly connected to each other.

4. The electrode terminal of claim 3, wherein at least two protective units are integrally formed, or at least one connection rib is provided between the two adjacent protective units, or the two adjacent protective units are glued to each other.

5. The electrode terminal of claim 2, wherein the two adjacent protective units are detachably connected.

6. The electrode terminal of claim 5, wherein the two adjacent protective units are slidably connected; or the two adjacent protective units are buckled with each other; or a connection member is provided between the two adjacent protective units; or the two adjacent protective units are magnetically connected.

7. The electrode terminal of claim 2, wherein the two adjacent protective units are movably connected.

8. The electrode terminal of claim 7, wherein the two adjacent protective units are rotatably connected.

9. The electrode terminal of claim 1, wherein the at least three protective units are provided with accommodation grooves for accommodating the at least three electrodes respectively; and the at least three protective units have an equal length and are sleeved at the at least three electrodes respectively.

10. The electrode terminal of claim 1, wherein the at least three protective units are provided with accommodation grooves for accommodating the at least three electrodes respectively, each of the at least three protective units comprises a first cylinder and a second cylinder of different lengths, the first cylinder and the second cylinder respectively sleeved at each of the at least three electrodes, the second cylinder exposes a top of each electrode for connection to a protector.

11. The electrode terminal of claim 10, wherein an exposed length of the top of each electrode is greater than or equal to 5 mm.

12. The electrode terminal of claim 10, wherein an isolation gap is provided between the protective cover and the surrounding plate.

13. The electrode terminal of claim 12, wherein the isolation gap has a width greater than or equal to 0.1 mm.

14. The electrode terminal of claim 10, wherein an avoidance port is provided between two first cylinders adjacent to the second cylinder, and is configured to avoid the protector.

15. The electrode terminal of claim 10, wherein a abutment portion is formed to protrude from an inner wall of the accommodation groove of the first cylinder, and the abutment portion abuts against a top surface of the electrodes.

16. The electrode terminal of claim 15, wherein the abutment portion abuts against a portion of the top surface of the electrode.

17. The electrode terminal of claim 10, wherein the electrodes are provided with an electrode sheet, and in the first cylinder, the electrode sheet is provided within the accommodation groove; and
in the second cylinder, the electrode sheet passes through the accommodation groove and is electrically connected to the protector.

18. The electrode terminal of claim 10, wherein a fixation portion is provided within the accommodation groove, and abuts against the electrodes.

19. A compressor, comprising the electrode terminal of claim 1.

20. A refrigeration device, comprising the compressor of claim 19.
